(19) United States
(12) Patent Application Publication
(10) Pub. No.: US 2025/0381957 A1
(43) Pub. Date: Dec. 18, 2025

(54) ADJUSTABLE CRUISE CONTROL SYSTEM

(71) Applicant: PACCAR Inc, Bellevue, WA (US)

(72) Inventors: Antonio Luna, Sunnyvale, CA (US); Steven Olson, Los Altos, CA (US)

(73) Assignee: PACCAR Inc, Bellevue, WA (US)

(21) Appl. No.: 18/741,518

(22) Filed: Jun. 12, 2024

(51) Int. Cl. B60W 30/14

(52) U.S. Cl. CPC B60W 30/146; B60W 2555/60; B60W 2710/0605

(57) ABSTRACT

An adjustable cruise control system on a vehicle includes a predictive cruise control (PCC) system optimized for energy efficiency and a driver-customized adaptive cruise control (DCACC) system optimized for a driver's driving preferences. The PCC system and DCACC system each generate control outputs, such as throttle control outputs. A cruise control weighting factor is used to weight the PCC control output(s) and the DCACC control output(s), thereby controlling the extent to which energy efficiency is emphasized versus driver preferences. The cruise control weighting factor may be provided to the vehicle computer before the cruise control system is engaged and/or may be changed while the cruise control system is active. The adjustable cruise control system may dynamically change the weighting factor in response to determining that a current driving scenario corresponds to a predetermined driving scenario.

### BACKGROUND

Most modern vehicles include cruise control systems that automatically maintain vehicle speed based on a setpoint speed provided by the driver. Such systems are intended to relieve the driver of the task of monitoring the vehicle's speed over long sections of highway and to improve energy efficiency by reducing accelerations/decelerations. Some cruise control systems are adaptive cruise control (ACC) systems that adjust the vehicle speed when needed to maintain a safe distance from vehicles in front.

Recently, some vehicles have begun to include predictive cruise control (PCC), which adjusts a vehicle's speed based on information about upcoming route conditions such as upcoming gradients. PCC systems typically use the upcoming route information to improve energy efficiency. For example, a PCC system may alter a vehicle's speed (e.g., to below or above the setpoint speed) when it detects that the vehicle is approaching a hill to reduce energy consumption during the climb and/or take advantage of the momentum it will gain after the crest of the hill. It is with respect to this general technical environment that aspects of the present disclosure are directed.

### SUMMARY

The disclosure generally relates to providing a customizable cruise control system that varies a weighting between a PCC system and a driver-customized ACC system (referred to herein as DCACC). Measurements of driver inputs (e.g., throttle and/or brake inputs) during various driving conditions are collected while a driver is driving a vehicle or operating a driving simulator.

In some examples, these measurements are analyzed to extract a set of driver parameters that represent the driver's preferring driving characteristics (e.g., the driver's preferred following distance, speed, acceleration profile, etc.) An ACC system can be customized using the driver parameters such that it causes a vehicle to behave more similarly to the driver's preferred driving style rather than simply maintaining a particular speed and time headway to a leading vehicle. That is, the DCACC is optimized for providing a better driving experience for the driver (while maintaining various safety-related guardrails, such as a minimum time headway and maximum speed).

In other examples, the driver data is used to train an ML model within a DCACC, thereby causing the DCACC to better model the driver's behavior.

A cruise control system that includes a PCC system and a DCACC system (or a combined PCC/DCACC system) can be adjusted by varying the weighting of a control output(s) determined by the PCC system relative to the weighting of a control output(s) determined by the DCACC system, thereby adjusting the performance of the cruise control system by switching between (or combining) the control outputs. In this manner, the cruise control system can be adjusted to trade off energy efficiency (which is maximized by using the PCC control output(s)) and the driver's driving experience (which is improved by using the DCACC control output(s)).

According to an example implementation, a method is described, the method comprising: providing a first throttle control output to a throttle controller of the vehicle to cause the vehicle to be controlled in accordance with the first throttle control output; determining a second throttle control output based at least in part on upcoming route information; determining a third throttle control output based at least in part on one or more parameters representing driver-preferred driving characteristics; obtaining a first cruise control weighting factor; determining a fourth throttle control output based at least in part on the first cruise control weighting factor, the second throttle control output, and the third throttle control output; providing the fourth throttle control output to the throttle controller of the vehicle to cause the vehicle to be controlled in accordance with the fourth throttle control output.

According to an example implementation, a method is described, the method comprising: obtaining a first cruise control weighting factor as a cruise control weighting factor, wherein the cruise control weighting factor is a selectable and variable indication of a preference for the cruise control system between a predictive cruise control (PCC) behavior and a driver-preferred driving behavior; determining, by a cruise control system, a first throttle control output based at least in part on first upcoming route information, parameters representing driver-preferred driving characteristics, and the first cruise control weighting factor; and providing the first throttle control output to a throttle controller of the vehicle to cause the vehicle to be controlled in accordance with the first throttle control output.

According to an example implementation, a system is described, the system comprising: at least one processor; and a memory including instructions, which when executed by the at least one processor, cause the system to: provide a first throttle control output to a throttle controller of a vehicle to cause the vehicle to be controlled in accordance with the first throttle control output; determine a second throttle control output based at least in part on upcoming route information; determine, by a cruise control system of the vehicle, a third throttle control output based at least in part on one or more parameters representing driver-preferred driving characteristics; obtain a first cruise control weighting factor; determine a fourth throttle control output based at least in part on the first cruise control weighting factor, the second throttle control output, and the third throttle control output; provide the fourth throttle control output to the throttle controller of the vehicle to cause the vehicle to be controlled in accordance with the fourth throttle control output.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIGS. 1A-1B depict block diagrams illustrating an operating environment in which aspects of an adjustable cruise control system may be implemented according to an example;

FIG. 2 is a diagram illustrating example control outputs of an adjustable cruise control system;

FIG. 3A is a flow diagram illustrating processing operations of a method that can be used to implement a driver-customized ACC according to an example;

FIGS. 3B-3C depict block diagrams illustrating example components that can be used to implement a driver-customized ACC according to an example;

FIGS. 4A-4C depict flow diagrams illustrating processing operations of methods that can be used for adjusting a cruise control system according to an example;

FIG. 5 is a flow diagram illustrating processing operations of a method that can be used for adjusting a cruise control system according to another example; and

FIG. 6 is a block diagram illustrating example physical components of a computing device or system with which examples may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. The following detailed description is, therefore, not to be taken in a limiting sense.

As mentioned above, vehicles may include adaptive cruise control (ACC) systems that roughly maintain a setpoint speed while also adjusting the speed as needed to maintain a safe distance (or time headway) to a leading vehicle. Some vehicles include a predictive cruise control (PCC) system instead of (or in addition to) an ACC system. The PCC system may adjust a vehicle's speed based on upcoming route information. For example, a PCC system may utilize a global positioning system (GPS) to monitor the vehicle's position relative to a map, which may include information about upcoming topography and turns, etc. Vehicles that are equipped with ACC and/or PCC systems typically include a vehicle computer that determines the control outputs that are used to control the throttle (and in some cases, the braking system and/or transmission system) of the vehicle. For example, throttle control signals can be provided to a throttle controller that controls the throttle of the vehicle, thereby causing the vehicle to accelerate or decelerate by controlling the inputs to the engine or motor of the vehicle. The throttle controller may control an amount of air and/or fuel supplied to an internal combustion engine or an amount of power provided to an electric motor. Additionally or alternatively, brake control signals can be provided to a brake controller to engage or disengage the brakes, such as by engaging or disengaging mechanical brakes, engine brakes, and/or regenerative brakes.

PCC systems are typically optimized for maximum energy efficiency and use upcoming route information (such as gradient, turning, or traffic information) to adjust the vehicle's speed in a manner that conserves energy (e.g., by conserving gasoline or battery power). Thus, the control outputs of a PCC system may be different from those of an ACC system. For example, an ACC system may attempt to maintain a fixed setpoint speed regardless of whether it is approaching a hill, which may cause the vehicle to use additional energy during a subsequent climb and/or descent. In contrast, a PCC system may adjust the vehicle's speed at the base of the hill (e.g., based on information that indicates that the hill is relatively long and/or steep and/or whether a descent follows the apex of the hill) to conserve energy during the climb and/or descent. PCC systems, like conventional ACC systems, do not consider a driver's specific driving preferences when determining control outputs.

Some drivers feel that cruise control systems, such as ACC and/or PCC systems, generally result in vehicle driving characteristics or behaviors that are different from what the driver would prefer (e.g., different from how the driver would drive the vehicle if it were not equipped with cruise control). For example, the ACC and/or PCC systems may deliver a rougher ride for a driver in terms of hard accelerations and decelerations. In other instances, the ACC and/or PCC systems may deliver slower accelerations or a different follow distance than the driver would prefer. Thus, drivers may be dissatisfied with the performance characteristics of the cruise control system and may be less likely to engage the system. As discussed herein, to address this issue, an ACC system can be modified to incorporate the driver's driving preferences, thereby creating a driver-customized ACC (DCACC) that offers a more “natural” driving experience for the driver. For example, the DCACC may accelerate differently (e.g., relative to a non-driver-customized ACC) or maintain a different time headway to a leading vehicle based on the driver's preferences. The DCACC system may provide improved driver satisfaction by optimizing for the driver's preferences (within an envelope of vehicle safety considerations), thereby increasing the likelihood that the driver will engage the DCACC system.

Systems and methods are described herein for providing an adjustable cruise control system by combining a PCC system with a DCACC system and weighting the control outputs of each of these systems to enable trade-offs between energy efficiency and driver preferences.

According to examples, an adjustable cruise control system on a vehicle includes a PCC system and a DCACC system, each of which may generate control outputs while the cruise control system is engaged. A cruise control weighting factor may be used to weight the PCC control outputs relative to the DCACC control outputs to vary the extent to which energy efficiency is emphasized versus driver preferences. In some examples, the cruise control weighting factor may be obtained by the vehicle computer when (e.g., at the time that) the cruise control system is engaged. In some examples, the cruise control weighting factor may be dynamically changed while the adjustable cruise control system is active.

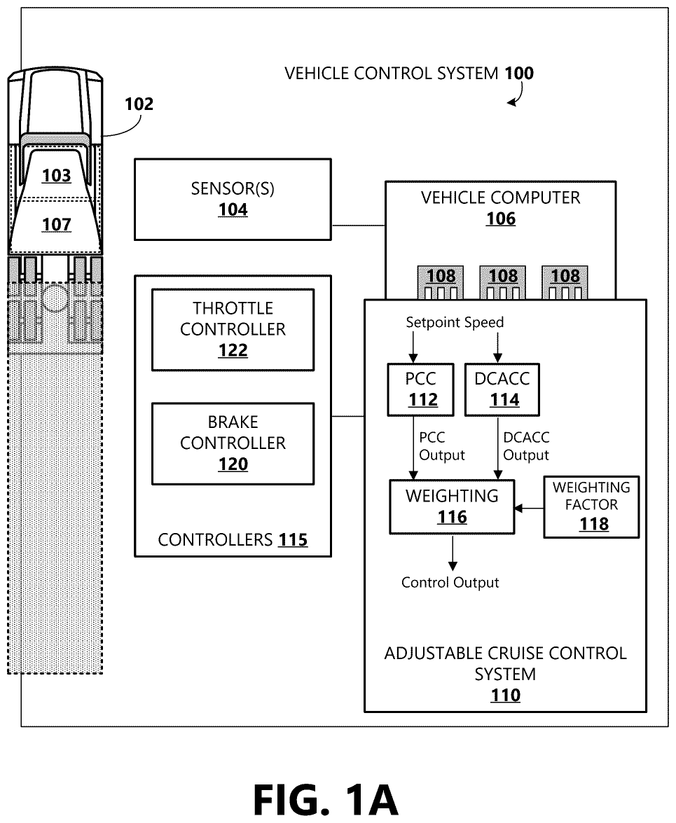

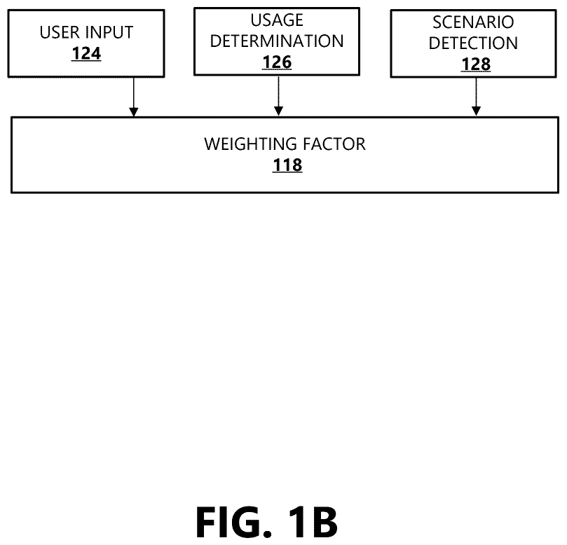

These and other examples are discussed below with reference to FIGS. 1A-6.

FIG. 1A is a block diagram illustrating an example vehicle control system 100 that is included in a vehicle 102. In some examples, the vehicle 102 is a heavy-duty truck, such as a Class 8 truck. For instance, the vehicle 102 may include a cab 103 compartment and a sleeper 107 compartment attached to the cab 103. It will be appreciated that aspects of the disclosed subject matter may have wide application and, therefore, may be suitable for use with any type of vehicle, such as passenger vehicles, motorcycles, buses, light, medium, and heavy-duty vehicles, trains, boats, yachts, motor homes, etc. Moreover, the methods and systems described herein can be used by vehicles that use various fuel types, including internal combustion engine (ICE) vehicles, hybrid vehicles, and electric vehicles. Accordingly, the following descriptions and illustrations herein should be considered illustrative in nature and, thus, do not limit the scope of the claimed subject matter.

According to an example implementation, the vehicle control system 100 may include one or more sensors 104, one or more controllers 115, and a vehicle computer 106. The vehicle computer 106 may be used to execute an adjustable cruise control system 110.

The sensors 104 may include one or more camera(s), LiDAR sensor(s), radar sensor(s), ultrasound sensor(s), inertial measurement unit (IMU) sensor(s), global positioning system (GPS) sensor(s), or other types of sensors. The sensors 104 may provide information about the physical environment of the vehicle 102, such as information about nearby vehicles or obstacles, roadway conditions, and/or an upcoming route.

The controllers 115 may include a throttle controller 122 for mechanically and/or electrically controlling inputs delivered to an engine or motor of the vehicle 102, thereby controlling the vehicle's speed and/or acceleration. The throttle controller 122 may include an actuator, for example, that mechanically and/or electrically controls the inputs to the engine or motor. In some cases, the controllers 115 may also include a brake controller 120 for mechanically and/or electrically controlling the brakes (which may include, for example, controlling the engine or motor of the vehicle 102 (for engine braking), physical brakes, and/or a regenerative braking system). The controllers 115 may control the throttle and/or brakes based on control signals received from the vehicle computer 106 (e.g., control outputs produced by the adjustable cruise control system 110, such as throttle control outputs).

The vehicle computer 106 includes one or more processing units 108 (e.g., microprocessors and/or other processing circuitry) and is configured to execute functions related to the adjustable cruise control system 110. The adjustable cruise control system 110 is configured to control a speed and/or acceleration of the vehicle 102 based on a setpoint speed (e.g., a target speed provided by the driver and/or determined by the adjustable cruise control system 110) and, as described in more detail below, based on throttle control outputs and cruise control weighting factors. The adjustable cruise control system 110 can be engaged (e.g., turned on, invoked) by a driver of the vehicle, such as by pressing a button or moving a lever in the vehicle. Similarly, the adjustable cruise control system 110 can be disengaged by the driver, such as by pressing the button, moving the lever, or applying the brakes.

The adjustable cruise control system 110 includes a predictive cruise control (PCC) system 112 and a driver-customized adaptive cruise control (DCACC) system 114. In some examples, the PCC system 112 and the DCACC system 114 are implemented separately (e.g., using separate programs and/or hardware). In some examples, the PCC system 112 and DCACC system 114 are implemented as a single, combined cruise control system (e.g., sharing certain software and/or hardware resources). The PCC system 112 and DCACC system 114 may each receive, as an input, a same setpoint speed, and may each produce control outputs based on the setpoint speed and various other factors described in more detail below. In some examples, the PCC system 112, DCACC system 114, and the adjustable cruise control system 110 may all be separately engageable (and disengageable) by a driver or other operator; while in other examples, only the adjustable cruise control system 110 (combining the PCC system 112 and DCACC system 114) may be engaged or disengaged by a driver or other operator.

The PCC system 112 is configured to determine a first throttle control output based on an upcoming route. For example, the PCC system 112 predicts upcoming gradient changes, traffic, turns, and or speed limit changes based on signals from the sensors 104 and/or based on navigation or map information stored on or received at the vehicle 102. The PCC system 112 uses the upcoming route information to determine a throttle control output that optimizes the energy efficiency of the vehicle 102 based on the characteristics of the upcoming route. Thus, the PCC system 112 output may be different from the output of a traditional cruise control system that maintains a steady speed and/or time headway to a leading vehicle regardless of the upcoming route. For example, if the PCC system 112 determines that a turn is coming up on the route, the PCC system 112 may determine a first throttle control output that is different from the throttle control output the PCC system would determine if there were no turn coming up. The first throttle control output may cause the vehicle to gradually decelerate in preparation for the turn rather than maintaining the setpoint speed and then braking at the turn.

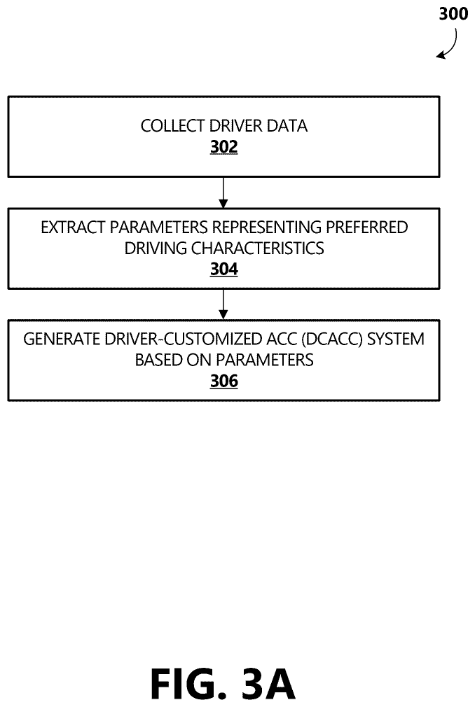

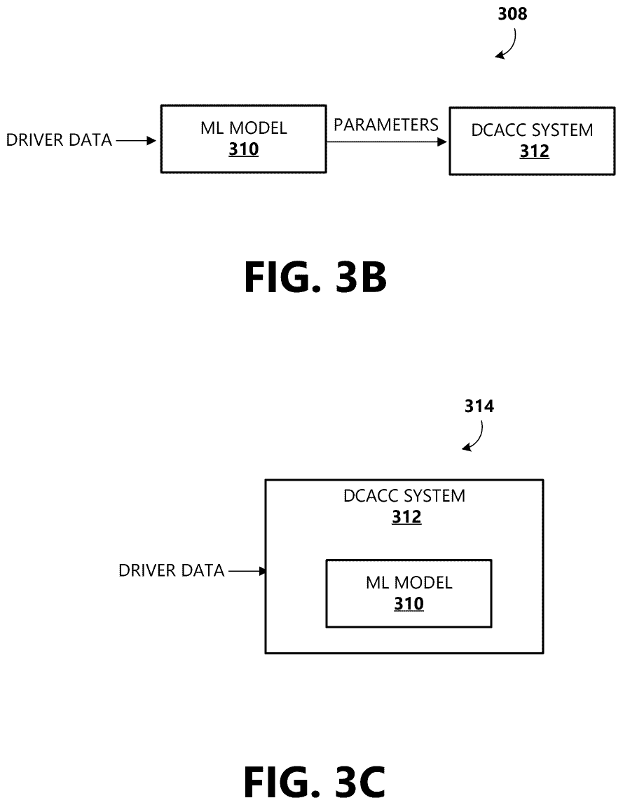

In this manner, the DCACC system 114 is configured to determine a second throttle control output. The second throttle control output is independent of upcoming route information and is instead based on a set of parameters representing driver-preferred driving characteristics (within various safety limits). As discussed in more detail with reference to FIGS. 3A-3B, in some examples, parameters are extracted (e.g., determined or identified) from data collected for a driver(s) while driving a vehicle or operating a vehicle simulator. The parameters may be extracted using a machine learning (ML) model, for example, and used to customize an adjustable cruise control system to create a DCACC system that imitates preferred driving behavior as represented by the parameters. In this case, the ML model may be included in the vehicle (e.g., stored in on-board memory of the vehicle) or may be stored remotely and process the data to extract the parameters off-line, away from the vehicle. Additionally or alternatively, the DCACC system itself may include an ML model that receives driver data (potentially in real-time, while the driver is driving the vehicle with the cruise control system disengaged), identifies preferred driving characteristics based on the driver data, and adjusts (e.g., continuously or intermittently, such as when the DCACC system is engaged by the driver) the DCACC system behavior based on the preferred driving characteristics. In some examples, driver data collected at the vehicle may be transmitted to a remote ML model (e.g., in real-time or near real-time), and the remote ML model may process the driver data to extract the parameters and transmit the parameters back to the vehicle by either a wireless connection (e.g., a cellular connection) or a wired connection (e.g., during maintenance stops at which a wired connection is available).

In non-exclusive examples, any type of supervised or unsupervised machine learning algorithms may be employed to generate and train an ML model, including neural networks, random forests, support vector machines, linear regression, polynomial regression, logistic regression, decision trees, hierarchical clustering, K-means clustering, principal component analysis, Guassian mixture models, density-based spatial clustering, etc.

Thus, the DCACC system 114 provides adaptive cruise control that attempts to mimic the driver's preferred driving style (e.g., in terms of acceleration profile, following distance, response to various driving scenarios, or other driving characteristics) within predetermined safety limits.

The adjustable cruise control system 110 includes a weighting system 116 that determines the final throttle control output provided to the throttle controller based on a cruise control weighting factor 118, the PCC throttle control output, and the DCACC throttle control output. The weighting system 116 weights the PCC throttle control output and the DCACC throttle control output to generate the final throttle control output based on (e.g., in accordance with) the cruise control weighting factor 118, thereby allowing trade-offs between optimizing for energy efficiency (e.g., by weighting the PCC throttle control output more heavily) or optimizing for driver preferences (e.g., by weighting the DCACC throttle control output more heavily).

The cruise control weighting factor 118 may be, for example, a numeric value that ranges from 0 to 1, a percentage that ranges from 0% to 100%, or a similar type of weighting factor. In some cases, a single cruise control weighting factor 118 can be used to determine the relative weightings for both the PCC and DCACC throttle control outputs. For example, if the cruise control weighting factor ranges from 0 to 1, the PCC control output can be weighted by the cruise control weighting factor and the DCACC throttle control output can be weighted by the value of (1—the cruise control weighting factor).

In some examples, the weighting system 116 uses the cruise control weighting factor 118 to generate the third throttle control output as a weighted combination of the PCC throttle control output and the DCACC throttle control output, which may include, for example, selecting either the PCC throttle control output or the DCACC throttle control output as the throttle control output provided to the throttle controller. For example, the weighting system 116 may multiply the PCC throttle control output by the cruise control weighting factor, multiply the DCACC throttle control output by (1—the cruise control weighting factor), and add the resulting weighted throttle control outputs to generate the throttle control output provided to the throttle controller. In some examples, the cruise control weighting factor may be set to 0, meaning that the throttle control output consists entirely of (e.g., is the same as) the second (DCACC) throttle control output because the PCC throttle control output has zero weighting. In other examples, the cruise control weighting factor may be set to 1, such that the throttle control output consists entirely of the first (PCC) throttle control output, while the DCACC throttle control output has zero weighting.

In some examples, the cruise control weighting factor may be selected to have a value between a minimum cruise control weighting factor and a maximum cruise control weighting factor, at least one of which is between 0 and 1 (non-inclusive). For example, the cruise control weighting factor for the PCC throttle control output may have a minimum value of (for example). 0.5 and a maximum value of 0.8, though other values are possible and contemplated. In this case, the corresponding cruise control weighting factor for the DCACC throttle control output (e.g., 1—the cruise control weighting factor) may have a minimum value of 0.2 and a maximum value of 0.5, such that adding the selected cruise control weighting factor and (1—the cruise control weighting factor) together results in a total value of 1. By constraining the weighting factor to lie within a certain range, the cruise control system can be adjusted while maintaining (for example) a minimum emphasis on energy efficiency. In examples, one or both of the PCC throttle control output and the DCACC throttle control output may be programmed to always have some influence (non-zero weighting) while the adjustable cruise control system 110 is engaged. For example, certain fleet operators may require that the PCC throttle control always have at least twenty percent weighting in order to maintain a certain energy efficiency.

In some examples, the weighting system 116 obtains the cruise control weighting factor 118 from a memory of the vehicle computer. For example, the cruise control weighting factor may be programmed into or stored in the vehicle computer (e.g., via a user interface). In some examples, the cruise control weighting factor 118 may be selected by a driver, e.g., through a displayed user interface into the vehicle computer 106, or by actuating a lever, button, dial or other element in the vehicle, which actuation may be interpreted by the vehicle computer as indicating a particular cruise control weighting factor 118. Additionally or alternatively, the weighting system 116 may obtain the cruise control weighting factor by receiving the cruise control weighting factor 118 over a wireless network, such as over a cellular or other wireless data network. For example, a fleet manager may selectively set (and modify) a cruise control weighting factor remotely. In some examples, the vehicle computer 106 and/or the adjustable cruise control system 110 may automatically update the cruise control weighting factor based on detecting a predetermined vehicle scenario and/or based on a measure of cruise control usage, such as discussed in more detail with reference to FIG. 1B.

In some examples, the weighting system 116 obtains the cruise control weighting factor 118 while the adjustable cruise control system 110 is disengaged (e.g., not operating) and/or while the adjustable cruise control system 110 is engaged (e.g., while the adjustable cruise control system 110 is periodically, intermittently, or continuously providing throttle control outputs to the throttle controller to control the speed and/or acceleration of the vehicle 102). In some cases, the performance characteristics of the adjustable cruise control system can be dynamically changed by changing the cruise control weighting factor 118 during operation of the adjustable cruise control system 110 (and/or between periods of operation of the adjustable cruise control system 110) to change the relative preference for (e.g., emphasis on) the PCC throttle control output vs the DCACC throttle control output.

Although the examples depicted herein describe controlling a throttle by providing throttle control outputs to a throttle controller 122, it should be appreciated that similar systems and methods can be used for brake control (e.g., via a brake controller 120).

FIG. 1B depicts example inputs that may cause the cruise control weighting factor 118 to be set or updated by the vehicle computer 106 and/or by the adjustable cruise control system 110.

For example, the cruise control weighting factor 118 may be set or updated in response to a user input 124 indicating a request to set or update the cruise control weighting factor 118 to a particular value. A user may input the cruise control weighting factor 118 via a local or remote user interface, for example, and the inputted cruise control weighting factor 118 may be provided to the adjustable cruise control system 110 via a wired or wireless connection. In some cases, the inputted cruise control weighting factor 118 is stored on the vehicle 102 and retrieved by the weighting system 116.

Additionally or alternatively, the cruise control weighting factor 118 may be automatically set or updated by the adjustable cruise control system 110 in response to a determination, by a usage determination system 126 of the adjustable cruise control system 110, that a measure of cruise control usage (such as a frequency of engagement and/or a duration of engagement) fails to satisfy a threshold. The measure of cruise control usage may fail to satisfy a threshold if the adjustable cruise control is disengaged for a threshold distance or a threshold duration while the vehicle is operating on one or more routes. For example, the measure of cruise control usage may fail to satisfy the threshold if the driver does not engage (or disengages) the cruise control system during route portions that are appropriate for the use of cruise control (e.g., during highway driving), which may be an indicator of driver dissatisfaction with the cruise control system. For example, the adjustable cruise control system 110 and/or vehicle computer 106 may maintain a history of the vehicle's highway driving and a percentage of time during that highway driving that the adjustable cruise control system 110 was engaged. Such percentage may be compared to one or more thresholds (or fed into a machine learning model) to determine if and when to trigger an adjustment to the weighting factor 118. In this case, the adjustable cruise control system may update the weighting factor 118 to more heavily weight the DCACC throttle control output relative to the PCC throttle control output in an effort to increase the driver's satisfaction with the system, thereby increasing the likelihood of its use by the driver. It may be desirable, from the perspective of a fleet operator, to encourage the driver to engage the adjustable cruise control system 110 in this manner because increased engagement of the adjustable cruise control system may lead to increased energy efficiency.

Additionally or alternatively, the cruise control weighting factor may be automatically set or updated by the adjustable cruise control system 110 in response to detection, by a scenario detection system 128 of the adjustable cruise control system 110, that a current driving scenario (e.g., a scenario that is currently occurring in time) corresponds to a predetermined driving scenario. Predetermined driving scenarios may be scenarios in which a driver is more likely to disengage a traditional cruise control system of a vehicle because it does not control the vehicle's speed or acceleration in a manner similar to what the driver would do in a similar scenario.

As an illustrative example, a driver may be likely to disengage a traditional cruise control system when another vehicle is passing the vehicle to avoid speeding up while the other vehicle is trying to pass. The scenario of a passing vehicle may therefore be stored as a predetermined driving scenario, and subsequent detection of a passing vehicle during driving may constitute detection of a driving scenario corresponding to a predetermined driving scenario. Scenarios like the passing vehicle scenario may be detected by a combination of sensors 104 (e.g., cameras, LiDAR, etc.). Other predetermined driving scenarios may include in-lane objects in front of the vehicle, potholes or bumps in the roadway, vehicles or hazards on the shoulder of the roadway, and/or traffic slowdowns, each of which may cause the driver to disengage a traditional cruise control system.

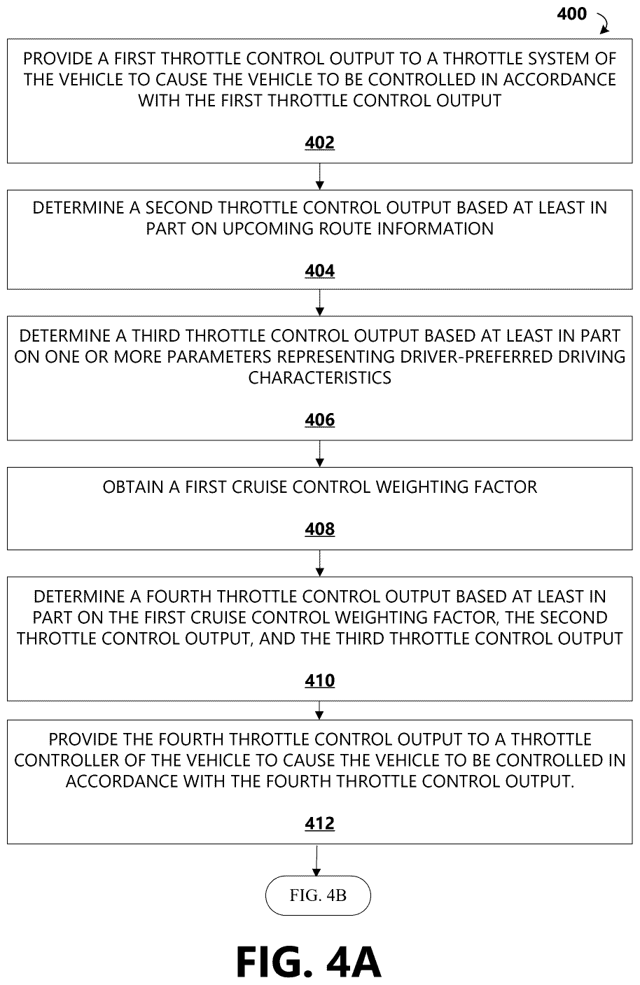

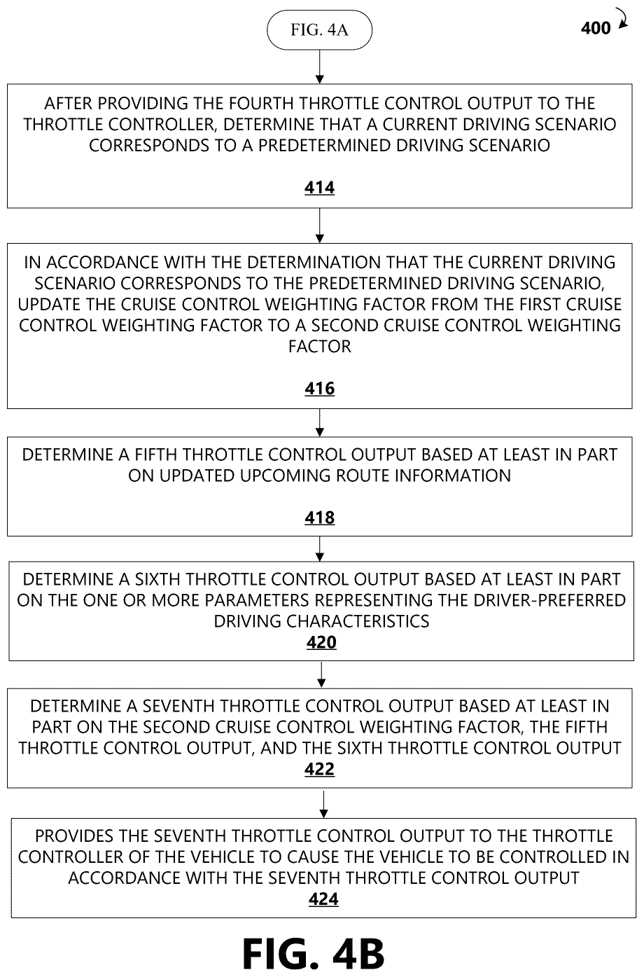

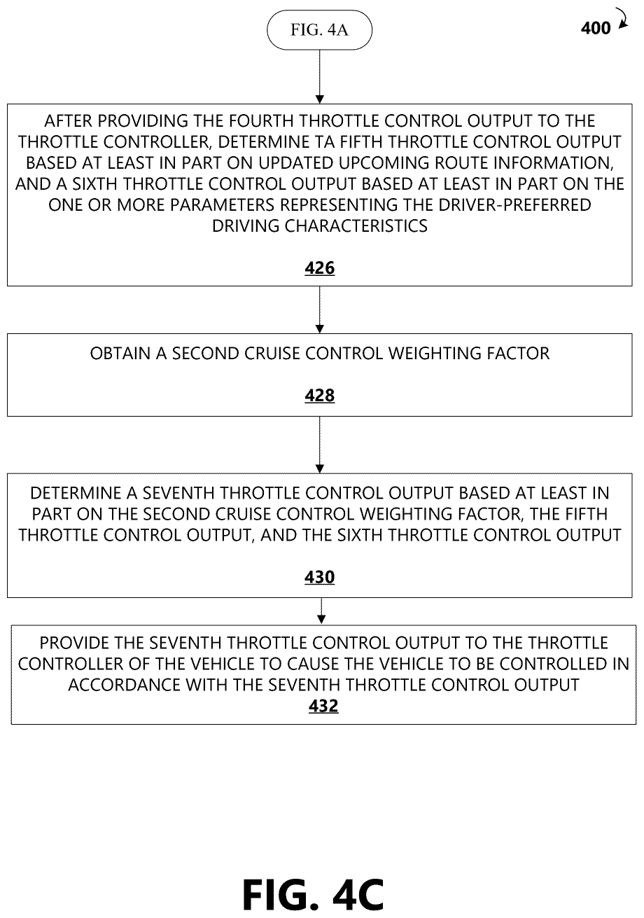

As discussed in more detail with reference to FIG. 4B, predetermined driving scenarios may be identified based on data collected for a driver(s) during a data collection process, and subsequently used to adjust the cruise control weighting factor 118 when a driving scenario that corresponds to a predetermined driving scenario is detected during operation of the adjustable cruise control system. In response to detecting a driving scenario corresponding to a predetermined scenario, the adjustable cruise control system may set or update the cruise control weighting factor to more heavily weight the DCACC throttle control output relative to the PCC throttle control output in an effort to cause the cruise control system to behave more like the driver would in this scenario and decrease the likelihood that the driver will disengage the cruise control system.

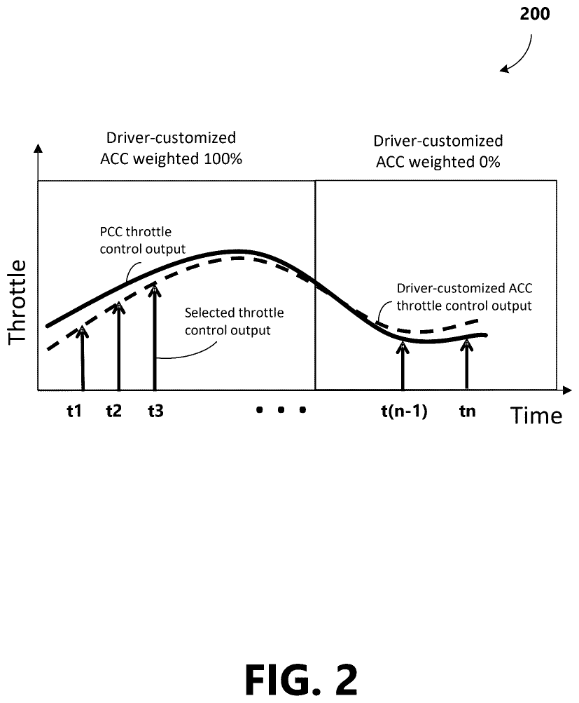

FIG. 2 depicts a diagram illustrating example control outputs of an adjustable cruise control system. In FIG. 2, the solid curved line represents a first throttle control output generated by a PCC system (e.g., PCC system 112), and the dashed curved line represents a second throttle control output generated by a DCACC system (e.g., DCACC system 114). As shown in the diagram 200, the two throttle control outputs are generally different over time because they are optimized for different metrics (e.g., energy efficiency vs driver-preferred driving characteristics). The vertical arrows represent points in time (t1, t2, t3, tN-1, tN) at which either the first throttle control output or the second throttle control output is selected based on a cruise control weighting factor that changes during the depicted time period.

For example, at times t1, t2, and t3, the cruise control weighting factor weights the PCC throttle control output at 100% (e.g., the cruise control weighting factor is set to 1 for the PCC throttle control output) and the DCACC throttle control output at 0% (e.g., the cruise control weighting factor is set to 0 for the DCACC throttle control output). Thus, at times t1, t2, and t3, the first throttle control output is provided to the throttle controller. In contrast, at times t(n-1) and tn, the reverse is true: the cruise control weighting factor has changed such that it weights the PCC throttle control output at 0% and the DCACC throttle control output at 100%. Thus, at times t(n-1) and tn, the second throttle control output is provided to the throttle controller.

Although in the example of FIG. 2, the cruise control weighting factor switches between 0 and 1 such that one throttle control output or the other is selected, it should be appreciated that the cruise control weighting factor can also be a numeric value between 0 and 1 (or between 0% and 100%, etc.) such that the two throttle control outputs are combined in a weighted combination that is then provided to the throttle control controller.

FIG. 3A is a flow diagram illustrating processing operations of a method that can be used to implement a DCACC system. In examples, one or more of the operations of FIG. 3A may be performed by vehicle control system 100 and one or more elements thereof, including adjustable cruise control system 110, vehicle computer 106, sensors 104, and/or controllers 115.

At operation 302, a computing system collects driver data while a driver is driving a vehicle and/or while a driver is operating a driving simulator. The collected driver data may include, for example, a maximum and/or minimum speed, an average speed, an acceleration profile (e.g., changes in acceleration over time), a maximum and/or minimum acceleration, a maximum and/or minimum jerk during acceleration, a maximum and/or minimum time headway to a leading vehicle, a maximum and/or minimum distance to a leading vehicle, for example. The driver data may be collected via a simulator or via the use of sensors on a vehicle, such as sensors that detect speed, acceleration, jerk, brake and/or throttle pedal position, throttle controller behavior, braking controller behavior, or other information about the vehicle's driving characteristics. In some examples, the driver data includes data about environmental conditions, including nearby vehicles, roadway conditions, weather, roadway signage, gradients, and/or traffic, that are detected via the sensors. Detected environmental conditions, along with detected co-occurring driving characteristics (such as disengagement of a cruise control system) may be analyzed by a computer system to identify the predetermined driving scenarios discussed with reference to FIG. 1B.

In some examples, the computing system collects driver data for one or more drivers. If the driver data is collected for a cohort of multiple drivers, the driver data may be averaged or otherwise normalized across the cohort. In examples, the cohort may be a broad population of drivers or may be specific groups (such as all drivers for a particular fleet). In some examples, the computing system also collects driver identification information that identifies the driver (or cohort) from which the data was collected, to enable driver- or cohort-specific customization of the DCACC system. For example, the computing system may detect (via radio-frequency or near-field-communication techniques) an identifier stored in a key fob or other device of the driver when the driver is in the vehicle.

Driver's may exhibit different driving behaviors depending on the type of vehicle being driven (e.g., the make, model, year, and/or optional equipment included in the vehicle). In some examples, the computing system collects vehicle identification information that identifies the type of vehicle from which the driver data was collected, to enable vehicle-specific customization of the DCACC system. For example, information about the type of vehicle being driven may be stored in association with an identifier of the vehicle (such as a vehicle identification number) that is detected by, or communicated to, the computing system. Thus, the DCACC system can be customized based on a particular driver's (or cohort's) driving preferences when driving a particular type of vehicle.

At operation 304, the computing system extracts parameters representing the driver-preferred driving characteristics. In some examples, the driver data collected at operation 302 (e.g., data for a single driver or data normalized across multiple drivers) is provided to a modeling tool or machine learning (ML) tool that extracts the parameters based on the collected driver data. For example, the parameters may represent a driver's preferred driving characteristics for one or more of the following characteristics: a minimum following distance to a leading vehicle, a maximum absolute velocity, a maximum velocity relative to the leading vehicle, a maximum absolute acceleration, a maximum acceleration relative to the leading vehicle, a maximum jerk, or a minimum time headway to the leading vehicle.

At operation 306, a driver-customized ACC system (such as DCACC 114) is generated (e.g., automatically or manually) based on the parameters extracted at operation 304 and optionally as described in more detail below, based on driver or cohort identification information and/or based on vehicle identification information. For example, a traditional ACC system may be modified (by a computing system or a person) to cause the system to determine control outputs, such as throttle control outputs and/or brake control outputs, based in part on the parameters representing the identified driver's (or cohort's) driving characteristics, such as by configuring the ACC system to determine a throttle control output to achieve a speed, acceleration, distance to leading vehicle, time headway to leading vehicle, or other performance characteristic that mimics throttle and/or brake controls provided by the driver(s) under similar driving conditions (e.g., on roadways having similar speed limits, similar traffic, similar driving scenarios, or other similarities).

As previously mentioned, in some examples, the data collected at operation 304 includes driver identification information associated with a particular driver or cohort and/or vehicle identification information associated with a vehicle (e.g., the vehicle that is operated by the driver(s) during the data collection process). Such identification information may subsequently be used to select a DCACC system (and/or to select a set of parameters for adjusting a DCACC system) that is specific to a particular driver or cohort, a particular vehicle, and/or a particular driver/vehicle combination. For example, multiple sets of parameters and/or multiple variations of a DCACC system may be stored on or accessed by a vehicle, where each set of parameters and/or variation of the DCACC system may be associated with particular driver identification information, particular vehicle identification information, or both. Upon startup of the vehicle and/or engagement of the cruise control system, the vehicle computer may identify the driver or cohort (e.g., by receiving a user input identifying the driver, by identifying a key fob of a driver, or by another method) and/or may identify the vehicle (e.g., based on a license plate, fleet number, or VIN number stored in a memory of the vehicle). The vehicle computer may select, based on the identified driver and/or vehicle, a particular pre-customized DCACC system (e.g., a system that has been customized for the identified driver and/or vehicle using a corresponding set of driver data or parameters) and/or may select a particular set of driver data or parameters with which to customize a baseline DCACC system.

In some examples, the operations shown in FIG. 3A are performed iteratively and/or as part of a closed-loop system in which driver data is collected continuously or intermittently while the driver is driving a vehicle (e.g., while the cruise control system is disengaged). The driver data can be used, by the ML model, to adjust the parameters representing the preferred driving characteristics. The adjusted parameters may in turn be used to adjust the behavior of the DCACC system. In this manner, the behavior of the DCACC may be adjusted over time to better reflect the driver's driving preferences.

FIG. 3B depicts a block diagram illustrating example components that can be used to implement a driver-customized cruise control system using the method described with reference to FIG. 3A. In this example, a machine learning (ML) model 310 receives driver data (e.g., collected as described with reference to operation 302) and analyzes the driver data (e.g., for one or more drivers) to extract a set of parameters representing preferred driving characteristics of the driver(s). The parameters are provided to a DCACC system 312 to customize the DCACC system 312, as described with reference to operation 306. The customized DCACC system 312 can then be used to control the throttle and/or brakes of the vehicle as described with reference to FIG. 1A. The ML model depicted may be included in memory of the vehicle or located remotely. In some cases, the process shown in FIG. 3A may be repeated as a driver is driving the vehicle to collect additional data and refine the parameters and/or the DCACC system 312. As shown in the DCACC system 314 of FIG. 3C, in some examples, the ML model is included in the DCACC system 314 itself and is used for real-time or near-real-time DCACC system adjustment based on receiving additional driver data while the driver is driving the vehicle, such as to refine the behavior of the DCACC system 114 to better match the preferred driving characteristics of the driver.

In some examples, if a driver is unrecognized (e.g., the driver is a new driver or one for whom driving data has not yet been collected), the system selects a baseline DCACC system (e.g., a DCACC system that has been customized for a different driver or cohort, or an uncustomized ACC system) and then refines the DCACC system (or ACC system) based on data collected for the new driver while driving the vehicle.

FIGS. 4A-4C depict flow diagrams illustrating processing operations of methods that may be performed by a vehicle computer of a vehicle (e.g., vehicle computer 106 of vehicle 102) that implements an adjustable cruise control system (e.g., adjustable cruise control system 110). Operations shown in FIGS. 4A-4C may be rearranged, and some operations may be added or omitted.

At operation 402, the vehicle computer provides a first throttle control output to a throttle controller of the vehicle to cause the vehicle to be controlled in accordance with the first throttle control output (e.g., while the cruise control system is engaged). In some examples, the first throttle control output is based on a weighted combination of a PCC throttle control output and a DCACC throttle control output, such as described with reference to FIGS. 1A-2. In some examples, before providing the first throttle control output to the throttle controller, the vehicle computer detects a user input requesting to engage the adjustable cruise control system and, in response to the user input, engages (e.g., activates, turns on) the adjustable cruise control system.

At operation 404, the vehicle computer determines a second throttle control output based at least in part on upcoming route information. For example, the vehicle determines the second throttle control output using a PCC system (e.g., PCC system 112), such as described with reference to FIG. 1A. In some examples, the vehicle computer determines the second throttle control output based on a setpoint speed provided by the driver (e.g., in addition to the upcoming route information). In some examples, the vehicle computer determines the second throttle output based on a topographic profile (e.g., gradient information) of the upcoming route, traffic on the upcoming route (e.g., additional vehicles that may cause slowdowns in traffic flow), turns in the upcoming route, and/or an upcoming speed limit, each of which may be provided to the vehicle or detected by the vehicle sensors, such as based on roadway signage, visible gradient changes, or other environmental characteristics.

At operation 406, the vehicle computer determines a third throttle control output based at least in part on one or more parameters representing driver-preferred driving characteristics. For example, the vehicle computer determines the third throttle control output using a DCACC system (e.g., a driver-customized adaptive cruise control system that determines throttle outputs based in part on a setpoint speed and in part on parameters representing driver-preferred driving characteristics, as described with reference to FIGS. 1A-3C).

At operation 408, the vehicle computer obtains (e.g., receives, generates, or retrieves) a first cruise control weighting factor (e.g., cruise control weighting factor 118). For example, a weighting system (e.g., weighting system 116) of the adjustable cruise control system obtains the first cruise control weighting factor as described with reference to FIGS. 1A-1B. In some examples, the vehicle computer obtains the first cruise control weighting factor in response to detecting the user input requesting to engage the cruise control system. In some examples, the vehicle computer obtains the first cruise control weighting factor in response to detecting that a current vehicle scenario corresponds to a predetermined vehicle scenario, or in response to determining that a measure of cruise control usage fails to satisfy a threshold.

At operation 410, the vehicle computer determines a fourth throttle control output based at least in part on the first cruise control weighting factor, the second throttle control output, and the third throttle control output. For example, a weighting system (e.g., weighting system 116) weights the second throttle control output and the third throttle control output based on the first cruise control weighting factor (e.g., as described with reference to FIGS. 1A-2) and determines (e.g., generates, computes) the fourth throttle control output based on the weighted second throttle control output and the weighted third throttle control output. In some examples, the fourth throttle control output is a weighted combination of the second throttle control output and the third throttle control output; e.g., the fourth throttle control output includes contributions from both the PCC system and the DCACC system. In some examples, determining the fourth throttle control output includes selecting the second throttle control output or the third throttle control output as the fourth throttle control output (e.g., selecting either the PCC throttle control output or the DCACC throttle control output to provide to the throttle controller, such as described with reference to FIG. 2.)

At operation 412, the vehicle computer provides the fourth throttle control output to a throttle controller (e.g., throttle controller 122) of the vehicle to cause the vehicle to be controlled in accordance with (e.g., based on) the fourth throttle control output.

In some examples, the vehicle computer performs operations 414-424 of FIG. 4B after performing operation 412. Additionally or alternatively, the vehicle computer may perform operations 426-432 of FIG. 4C after performing operation 412.

With reference to FIG. 4B, at operation 414, after providing the fourth throttle control output to the throttle controller, the vehicle computer determines that a current driving scenario corresponds to a predetermined driving scenario. For example, vehicle computer identifies a current (e.g., a currently occurring) driving scenario based on the most recent signals received from sensors on the vehicle, and compares the current driving scenario to one or more predetermined driving scenarios, such as those described with reference to FIG. 1B. The vehicle computer determines that the current driving scenario corresponds to a predetermined driving scenario if characteristics of the current driving scenario match those of the predetermined driving scenario, such as if the vehicle computer determines, based on sensor signals, that another vehicle is passing the vehicle.

At operation 416, in accordance with the determination that the current driving scenario corresponds to the predetermined driving scenario, the vehicle computer updates a cruise control weighting factor from the first cruise control weighting factor to a second cruise control weighting factor. In some examples, in accordance with the determination that the current driving scenario corresponds to the predetermined driving scenario, the vehicle computer updates the cruise control weighting factor to more heavily weight a throttle control output from the DCACC system relative to a throttle control output from the PCC system. In some examples, after updating the cruise control weighting factor to the second cruise control weighting factor, the vehicle computer determines that an (updated) current driving scenario fails to correspond to the predetermined driving scenario, and in response, reverts to the first cruise control weighting factor. For example, if the vehicle computer determines that another vehicle is no longer passing the vehicle, the vehicle computer reverts to the cruise control weighting factor that was in use before the vehicle computer detected the passing vehicle.

At operation 418, the vehicle computer determines a fifth throttle control output based at least in part on updated upcoming route information, in a manner similar to that described with reference to operation 404.

At operation 420, the vehicle computer determines a sixth throttle control output based at least in part on the one or more parameters representing the driver-preferred driving characteristics, in a manner similar to that described with reference to operation 406.

At operation 422, the vehicle computer determines a seventh throttle control output based at least in part on the second cruise control weighting factor, the fifth throttle control output, and the sixth throttle control output, in a manner similar to that described with reference to operation 408.

At operation 424, the vehicle computer provides the seventh throttle control output to the throttle controller of the vehicle to cause the vehicle to be controlled in accordance with the seventh throttle control output, in a manner similar to that described with reference to operation 410.

Turning now to FIG. 4C, at operation 426, after providing the fourth throttle control output at operation 412, the vehicle computer determines a fifth throttle control output based at least in part on updated upcoming route information and a sixth throttle control output based at least in part on the one or more parameters representing the driver-preferred driving characteristics, such as previously described with reference to operations 404 and 406.

At operation 428, the vehicle computer obtains a second cruise control weighting factor, such as described with reference to operation 408. For example, the vehicle computer receives the second cruise control factor from a local or remote source and/or generates the second cruise control weighting factor based on detecting that a current driving scenario corresponds to a predetermined driving scenario.

At operation 430, the vehicle computer determines a seventh throttle control output based at least in part on the second cruise control weighting factor, the fifth throttle control output, and the sixth throttle control output, such as described with reference to operation 410.

At operation 432, the vehicle computer provides the seventh throttle control output to the throttle controller of the vehicle to cause the vehicle to be controlled in accordance with the seventh throttle control output, such as described with reference to operation 412.

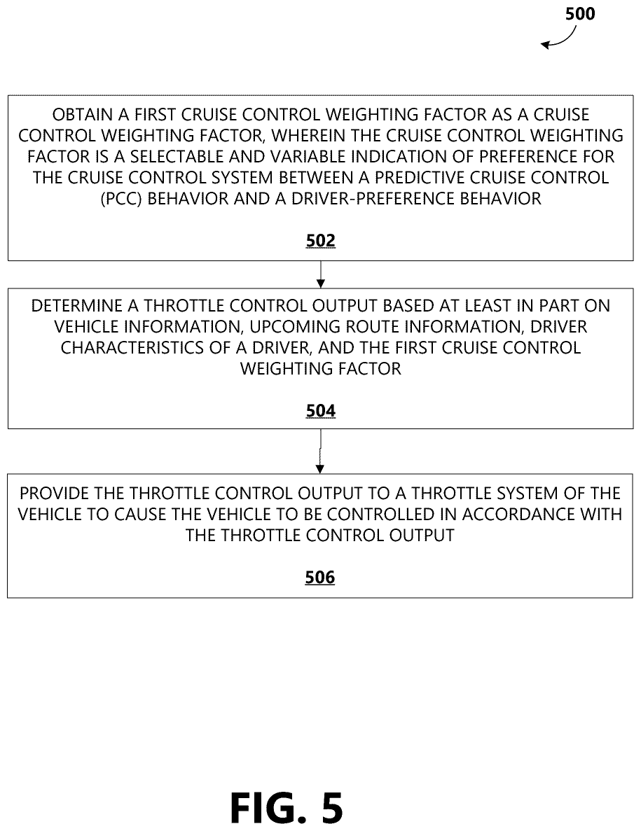

FIG. 5 depicts a flow diagram illustrating processing operations of a method that may be performed by a vehicle computer of a vehicle (e.g., vehicle computer 106 of vehicle 102, which may be or may include a computing device such as computing device 600).

At operation 502, the vehicle computer obtains a first cruise control weighting factor (e.g., cruise control weighting factor 118) as a cruise control weighting factor, where the cruise control weighting factor is a selectable and variable indication of preference for an adjustable cruise control system (e.g., adjustable cruise control system 110) between a predictive cruise control (PCC) behavior and a driver-preferred driving behavior (.

At operation 504, the vehicle computer determines a first throttle control output based at least in part on first upcoming route information, parameters representing driver-preferred driving characteristics, and the first cruise control weighting factor. For example, the vehicle computer determines the first throttle control output by determining whether the current vehicle scenario corresponds to a predetermined vehicle scenario (based on the sensor information), based on a throttle control output generated by a DCACC system (where the DCACC system incorporates parameters representing driver-preferred driving behavior), and the first cruise control weighting factor (which may be used to weight the throttle control output generated by a PCC system relative to the throttle control output generated by the DCACC system). In some examples, the vehicle computer also determines the first throttle control output based at least in part on a speed setpoint.

At operation 506, the vehicle computer provides the first throttle control output to a throttle controller of the vehicle to cause the vehicle to be controlled in accordance with the first throttle control output, in a manner similar to that described with reference to operation 412 of FIG. 4A.

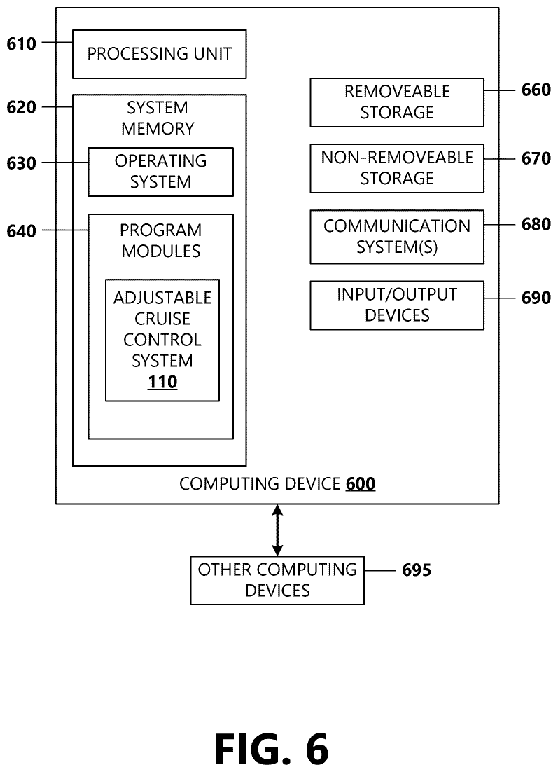

FIG. 6 is a block diagram illustrating example physical components of a computing device or system with which examples may be practiced.

As shown in FIG. 6, the physical components (e.g., hardware) of the computing device 600 are illustrated and these physical components may be used to practice the various aspects of the present disclosure. The computing device 600 may be or may be included in a vehicle computer of a vehicle as described with reference to FIG. 1A.

The computing device 600 may include at least one processing unit 610 and a system memory 620. The system memory 620 may include, but is not limited to, volatile storage (e.g., random access memory), non-volatile storage (e.g., read-only memory), flash memory, or any combination of such memories. The system memory 620 may also include an operating system 630 that controls the operation of the computing device 600 and one or more program modules 640. The program modules 640 may be responsible for performing one more of the operations of the methods described above for implementing an adjustable cruise control system 110. A number of different program modules and data files may be stored in the system memory 620. While executing on the processing unit 610, the program modules 640 may perform the various processes described above.

The computing device 600 may also have additional features or functionality. For example, the computing device 600 may include additional data storage devices (e.g., removable and/or non-removable storage devices) such as, for example, magnetic disks, optical disks, or tape. These additional storage devices are labeled as a removable storage 660 and a non-removable storage 670.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 6 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 600 on the single integrated circuit (chip). The disclosure may also be practiced using other technologies capable of performing logical operations such as, for example, AND, OR, and NOT, including but not limited to mechanical, optical, fluidic, and quantum technologies.

The computing device 600 may include one or more communication systems 680 that enable the computing device 600 to communicate with other computing devices 695. Examples of communication systems 680 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 600 may also have one or more input devices and/or one or more output devices shown as input/output devices 690. These input/output devices 690 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 620, the removable storage 660, and the non-removable storage 670 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 600. Any such computer storage media may be part of the computing device 600. Computer storage media does not include a carrier wave or other propagated or modulated data signal.

Programming modules may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

The description and illustration of one or more aspects provided in this application are intended to provide a thorough and complete disclosure of the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

We claim:

1. A method performed by an adjustable cruise control system of a vehicle, the method comprising:
providing a first throttle control output to a throttle controller of the vehicle to cause the vehicle to be controlled in accordance with the first throttle control output;
determining a second throttle control output based at least in part on upcoming route information;
determining a third throttle control output based at least in part on one or more parameters representing driver-preferred driving characteristics;
obtaining a first cruise control weighting factor;
determining a fourth throttle control output based at least in part on the first cruise control weighting factor, the second throttle control output, and the third throttle control output;
providing the fourth throttle control output to the throttle controller of the vehicle to cause the vehicle to be controlled in accordance with the fourth throttle control output.

2. The method of claim 1 wherein the fourth throttle control output is a weighted combination of the second throttle control output and the third throttle control output based on the first cruise control weighting factor.

3. The method of claim 1, wherein determining the fourth throttle control output comprises selecting the second throttle control output or the third throttle control output based on the first cruise control weighting factor.

4. The method of claim 1, further comprising:
determining the second throttle control output based on one or more of: a topographic profile of the upcoming route, traffic on the upcoming route, turns in the upcoming route, or an upcoming speed limit.

5. The method of claim 4, wherein one or more of the topographic profile of the upcoming route, the traffic on the upcoming route, the turns in the upcoming route, or the upcoming speed limit is detected by one or more sensors on the vehicle.

6. The method of claim 1, further comprising:
after providing the fourth throttle control output to the throttle controller, determining that a current driving scenario corresponds to a predetermined driving scenario;
in accordance with the determination that the current driving scenario corresponds to the predetermined driving scenario, automatically updating the first cruise control weighting factor to a second cruise control weighting factor;
determining a fifth throttle control output based at least in part on updated upcoming route information, and
determining a sixth throttle control output based at least in part on the one or more parameters representing the driver-preferred driving characteristics;
determining a seventh throttle control output based at least in part on the second cruise control weighting factor, the fifth throttle control output, and the sixth throttle control output;
providing the seventh throttle control output to the throttle controller of the vehicle to cause the vehicle to be controlled in accordance with the seventh throttle control output.

7. The method of claim 6, wherein the predetermined driving scenario corresponds to another vehicle passing the vehicle.

8. The method of claim 6, wherein the determination that the current driving scenario corresponds to the predetermined scenario is based on information received from one or more sensors of the vehicle.

9. The method of claim 1, further comprising:
after providing the fourth throttle control output, determining:
a fifth throttle control output based at least in part on updated upcoming route information, and
a sixth throttle control output based at least in part on the one or more parameters representing the driver-preferred driving characteristics;
obtaining a second cruise control weighting factor;
determining a seventh throttle control output based at least in part on the second cruise control weighting factor, the fifth throttle control output, and the sixth throttle control output; and
providing the seventh throttle control output to the throttle controller of the vehicle to cause the vehicle to be controlled in accordance with the seventh throttle control output.

10. The method of claim 9, wherein obtaining the second cruise control weighting factor comprises generating the second cruise control weighting factor based on a measure of cruise control usage, and wherein the second cruise control weighting factor increases a weight of the sixth throttle control output versus a weight of the fifth throttle control output based on the measure.

11. The method of claim 1, further comprising:
before providing the first throttle control:
detecting a user input requesting to engage the cruise control system, and
engaging the cruise control system in response to detecting the user input, wherein the first cruise control weighting factor is obtained in response to the user input.

12. The method of claim 1, wherein the one or more parameters representing driver-preferred driving characteristics comprise one or more parameters representing one or more of: a driver's preferred minimum following distance to a leading vehicle, a maximum absolute velocity, a maximum velocity relative to the leading vehicle, a maximum absolute acceleration, a maximum acceleration relative to the leading vehicle, a maximum jerk, or a minimum time headway to the leading vehicle.

13. A method performed by an adjustable cruise control system of a vehicle, the method comprising:
obtaining a first cruise control weighting factor as a cruise control weighting factor, wherein the cruise control weighting factor is a selectable and variable indication of a preference for the cruise control system between a predictive cruise control (PCC) behavior and a driver-preferred driving behavior;
determining, by a cruise control system, a first throttle control output based at least in part on first upcoming route information, parameters representing driver-preferred driving characteristics, and the first cruise control weighting factor; and
providing the first throttle control output to a throttle controller of the vehicle to cause the vehicle to be controlled in accordance with the first throttle control output.

14. The method of claim 13, wherein obtaining the first cruise control weighting factor comprises obtaining the first cruise control weighting factor based on information received from sensors on the vehicle.

15. The method of claim 13, further comprising:
after providing the first throttle control output to the throttle controller, receiving a second cruise control weighting factor that is different from the first cruise control weighting factor;
determining, by the cruise control system, a second throttle control output based at least in part on second upcoming route information, the parameters representing driver-preferred driving characteristics, and the second cruise control weighting factor; and
providing the second throttle control output to a throttle controller of the vehicle to cause the vehicle to be controlled in accordance with the second throttle control output.

16. A system, comprising:
at least one processor; and
a memory including instructions, which when executed by the at least one processor, cause the system to:
provide a first throttle control output to a throttle controller of a vehicle to cause the vehicle to be controlled in accordance with the first throttle control output;
determine a second throttle control output based at least in part on upcoming route information;
determine, by a cruise control system of the vehicle, a third throttle control output based at least in part on one or more parameters representing driver-preferred driving characteristics;
obtain a first cruise control weighting factor;
determine a fourth throttle control output based at least in part on the first cruise control weighting factor, the second throttle control output, and the third throttle control output;
provide the fourth throttle control output to the throttle controller of the vehicle to cause the vehicle to be controlled in accordance with the fourth throttle control output.

17. The system of claim 16, wherein the fourth throttle control output is a weighted combination of the second throttle control output and the third throttle control output based on the first cruise control weighting factor.

18. The system of claim 17, wherein the instructions further cause the system to:
after providing the fourth throttle control output, determine:
a fifth throttle control output based at least in part on upcoming route information, and
a sixth throttle control output based at least in part on the one or more parameters representing the driver-preferred driving characteristics;
obtain a second cruise control weighting factor;
determine a seventh throttle control output based at least in part on the second cruise control weighting factor, the fifth throttle control output, and the sixth throttle control output; and
provide the seventh throttle control output to the throttle controller of the vehicle to cause the vehicle to be controlled in accordance with the seventh throttle control output.

19. The system of claim 18, wherein the instructions cause the system to obtain the second cruise control weighing factor in response to detecting that the current vehicle scenario corresponds to a predetermined vehicle scenario.

20. The system of claim 18, wherein the instructions cause the system to obtain the second cruise control weighing factor in response to determining that a measure of cruise control usage (such as a frequency of engagement and/or a duration of engagement) fails to satisfy a threshold.
